(19) United States
(12) Patent Application Publication
(10) Pub. No.: US 2026/0171442 A1
(43) Pub. Date: Jun. 18, 2026

(54) HYDROGEN STORAGE DEVICE FOR FUEL CELL VEHICLE AND METHOD FOR CONTROLLING THE SAME

(71) Applicants: Hyundai Motor Company, Seoul (KR); Kia Corporation, Seoul (KR)

(72) Inventors: Yun Sik Kim, Seoul (KR); Myeong Woo Gye, Hwaseong-Si (KR)

(21) Appl. No.: 19/299,209

(22) Filed: Aug. 13, 2025

(30) Foreign Application Priority Data
Dec. 17, 2024 (KR) 10-2024-0189168

(51) Int. Cl. H01M 8/04082; H01M 8/04302; H01M 8/0432; H01M 8/0438; H01M 8/04746

(52) U.S. Cl. CPC H01M 8/04201; H01M 8/04302; H01M 8/0432; H01M 8/04432; H01M 8/04753; H01M 2250/20

(57) ABSTRACT

Disclosed are a hydrogen storage device for a fuel cell vehicle that may secure stabilization of a pressure relief valve that causes a leak problem due to a failure of a pressure maintenance performance of a regulator and may protect the hydrogen storage device from an excessive pressure by discharging hydrogen of the excessive pressure generated in the regulator to an outside as well, and a method for controlling the same.

### CROSS-REFERENCE TO RELATED APPLICATION

This application claims the benefit of priority to Korean Patent Application No. 10-2024-0189168, filed in the Korean Intellectual Property Office on Dec. 17, 2024, the entire contents of which are incorporated herein by reference.

### TECHNICAL FIELD

The present disclosure relates to a hydrogen storage device for a fuel cell vehicle, and a method for controlling the same.

### BACKGROUND

Eco-friendly vehicles (e.g., hybrid vehicles, electric vehicles, and fuel cell vehicles) may be equipped with high-voltage batteries that apply electric power to a driving motor.

Fuel cell vehicles are equipped with a fuel cell system that is configured to charge a high-voltage battery with electric power.

The fuel cell vehicles generate their own electricity via a chemical reaction between hydrogen and oxygen. The fuel cell vehicles include a hydrogen tank that stores high-pressure hydrogen, an air compressor that supplies air, and a fuel cell stack that generates electric energy via the electrochemical reaction between hydrogen and oxygen in the air.

Primary depressurization of hydrogen fuel being supplied to the fuel cell stack is performed by a regulator in a system for supplying high-pressure hydrogen from the hydrogen tank to the fuel cell stack.

The regulator may be connected to a port on a manifold that connects the hydrogen tank, so as to transfer a consistent filling pressure or a consistent tank pressure to an inlet.

However, when/if the fuel cell vehicle is exposed to a physical low-temperature environment for a long time, an operability of a piston, among the components of the regulator, may be lowered/hindered. Accordingly, a pressure (e.g., a regulator pressure) of hydrogen supplied to the regulator may be decreased.

When/if the vehicle is started and the temperature of the hydrogen being supplied rises, the pressure of the hydrogen may rise excessively to become an excessive pressure of hydrogen being supplied to the fuel cell stack. At the same time, the degradation problem of the operability of the regulator (e.g., of the piston of the regulator) may not be solved/improved. Thus, a pressure relief valve (PRV) that functions to adjust the pressure of the regulator may frequently be exposed to an excessive pressure (e.g., at a rear end of the regulator valve), so that a leakage phenomenon may occur in the pressure relief valve. A user of the vehicle may feel uncomfortable due to operation noise during the leakage, and excessive leakage may cause excessive wear on the pressure relief valve and related components.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a hydrogen storage device for a fuel cell vehicle. A hydrogen storage device for a fuel cell vehicle may comprise a controller comprising: one or more processors; and a memory storing instructions that, when executed, configure the controller to: detect, via a pressure sensor, a pressure of hydrogen supplied to a regulator; detect, via a temperature sensor, a temperature of hydrogen in the hydrogen storage device; and determine, based on the pressure and the temperature, a change in the pressure of hydrogen supplied to the regulator, and control, based on the change in the pressure indicating a lowered pressure, the regulator to compensate for the change in the pressure; and the regulator configured to compensate, by opening or closing a regulator valve of the regulator based on the control by the controller, for the change in the pressure.

Also, or alternatively, a method for controlling a hydrogen storage device for a fuel cell vehicle may comprise: detecting, via a pressure sensor and based on an off-signal of an ignition power source of the fuel cell vehicle, an initial pressure of hydrogen supplied to a regulator ; based on detecting a repeated wakeup signal: detecting, via a temperature sensor, a temperature of an interior of a hydrogen storage device; and detecting, via the pressure sensor, a pressure of hydrogen supplied to the regulator; based on the temperature being lower than a reference temperature, determining that at least one of the pressure of hydrogen or the initial pressure is lower than a reference pressure; and causing, based on the pressure or the initial pressure being lower than the reference pressure, opening of a regulator valve of the regulator.

Also, or alternatively method for controlling a hydrogen storage device for a fuel cell vehicle, the method comprising: detecting, via a pressure sensor and based on an off-signal of an ignition power source of the fuel cell vehicle, an initial pressure of hydrogen supplied to a regulator; based on detecting a repeated wakeup signal: detecting, via a temperature sensor, a temperature of an interior of a hydrogen storage device; and detecting, via the pressure sensor, a pressure of hydrogen supplied to the regulator; and based on the temperature being higher than a reference temperature, causing opening of a valve to discharge hydrogen from the hydrogen storage device to an outside to maintain a pressure state in the regulator.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a view schematically illustrating a configuration of a hydrogen storage device for a fuel cell vehicle according to an example of the present disclosure;

FIG. 2 is a view illustrating a controller of a hydrogen storage device for a fuel cell vehicle according to an example of the present disclosure;

FIG. 3 is a flowchart illustrating a method for controlling a hydrogen storage device for a fuel cell vehicle according to an example of the present disclosure; and

FIG. 4 is a flowchart illustrating a method for controlling a hydrogen storage device for a fuel cell vehicle according to another example of the present disclosure.

### DETAILED DESCRIPTION

Hereinafter, some examples of the present disclosure will be described in detail with reference to the accompanying drawings. In adding reference numerals to the components of the drawings, it should be noted that the same components have the same numerals as possible even when they are illustrated on different drawings. In describing examples of the present disclosure, detailed descriptions associated with well-known functions or configurations will be omitted if they may make subject matters of the present disclosure unnecessarily obscure.

Furthermore, in describing components of examples of the present disclosure, the terms first, second, A, B, (a), (b), and the like may be used herein. These terms are only used to distinguish one component from another component, but do not limit the corresponding components irrespective of the nature, order, or priority of the corresponding components. When it is described that a certain component is “connected to”, “coupled to” or “electrically connected to” a second component, it should be understood that the component may be directly connected or electrically connected to the second component, but a third component may be “connected”, “coupled” or “electrically connected” between the components.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

The expression “based on” as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Throughout the present disclosure, references to units generally refer to items that logically can be grouped together to perform a function or group of related functions. Like reference numerals are generally intended to refer to the same or similar components. Units herein may be implemented in software, hardware or a combination of software and hardware. The units and/or functions described herein may be implemented and/or performed by one or more processors. For examples, the units may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The units may also, or alternatively, include software control module(s) implemented with a processor and/or logic circuitry, for example. The units may include and/or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

Hereinafter, a hydrogen storage device 100 for a fuel cell vehicle according to an example of the present disclosure will be described in detail with reference to the accompanying drawings.

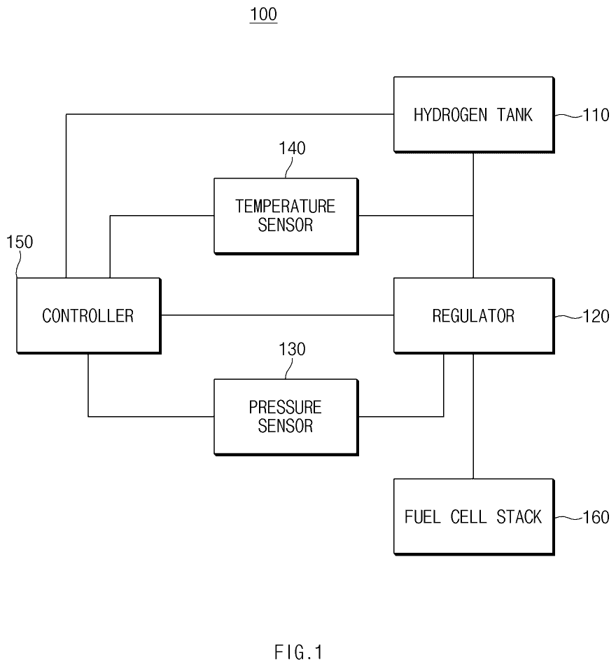

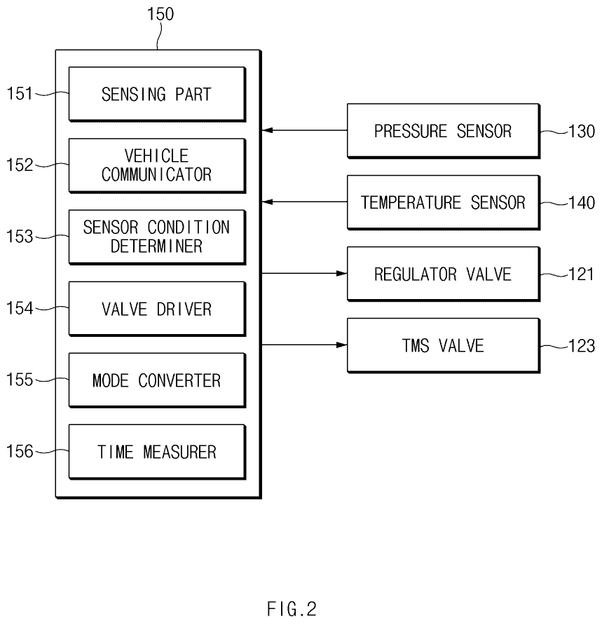

FIG. 1 is a view schematically illustrating a configuration of a hydrogen storage device 100 for a fuel cell vehicle according to an example of the present disclosure, and FIG. 2 is a view illustrating a controller 150 (e.g., a control device, a control computing device) of the hydrogen storage device 100 for a fuel cell vehicle according to an example of the present disclosure.

Referring to FIG. 1, the hydrogen storage device 100 may supply hydrogen to generate electric energy of a fuel cell stack 160 in a fuel cell vehicle. The hydrogen storage device 100 may include a hydrogen tank 110, a regulator 120, a pressure sensor 130, a temperature sensor 140, and a controller 150.

The hydrogen tank 110 may store hydrogen for use as fuel by the fuel cell vehicle (and/or other device to be fueled by the fuel cell stack). The hydrogen may be stored compressed at a high pressure in the hydrogen tank, which may be stored/provided in the fuel cell vehicle. The hydrogen tank 110 may be manufactured from a material capable of withstanding high pressure (e.g., carbon fiber reinforced composites). The at least one hydrogen tank 110 may be mounted on the fuel cell vehicle. The hydrogen tank 110 may be equipped with a solenoid valve (not illustrated) that opens or shuts off a flow path of hydrogen supplied to the fuel cell stack 160.

The regulator 120 may reduce a pressure of high-pressure hydrogen (e.g., about 700 bar) supplied from the hydrogen tank 110 to a specific supply pressure and/or supply pressure range (e.g., decompress the high-pressure hydrogen to the specific supply pressure and/or to within the specific supply pressure range). The regulator 120 may supply decompressed hydrogen to the fuel cell stack 160.

A pressure sensor 130 may be mounted on a fuel supply system/portion of the fuel supply system connecting the regulator 120 and the fuel cell stack 160. The pressure sensor 130 may measure a pressure of hydrogen being supplied to the regulator 120 to the fuel cell stack 160. The pressure sensor 130 may be implemented as a mid-pressure sensor. The pressure sensor 130 may also, or alternatively be implemented directly in the regulator and/or at an outlet of the regulator. The pressure sensor 130 may also, or alternatively, be implemented at or before an inlet of the regulator to measure the pressure of hydrogen supplied to the regulator.

The controller 150 (e.g., a hydrogen storage system management unit: HMU) may control an overall operation of the components of the hydrogen storage device 100. The controller 150 may acquire a sensor value associated with the hydrogen storage device 100, control the regulator valve 121, perform filling communication with/via a hydrogen filling station and a vehicle communicator 152, and/or control filling of hydrogen to the at least one hydrogen tank 110.

The controller 150 may comprise a hardware device such as a processor (e.g., a central processing unit (CPU)), a memory and/or a program stored on a memory and/or implemented by a processor. The controller 150 may include a communication device communicating with other controllers or a sensor to control one or more functions and/or operations in charge, a memory storing an operation system, a logic command, and input/output information, and/or one or more processors performing determination, calculation, and decision necessary for controlling the function in charge. The controller 150 may include, for example, a processor, a central processing unit (CPU), a microchip, a logic, an application-specific integrated circuit (ASIC), memory, etc. The controller may manipulate and/or control other components in the fuel supply system and/or the vehicle.

The controller 150 may determine/identify an operation state of the hydrogen storage device 100 (e.g., in real time). For example, the controller may determine/identify temperature and/or pressure states of hydrogen according to/associated with/characteristic of the operation state of the hydrogen storage device 100.

The controller 150 may include a sensing part 151 (e.g., one or more sensors), a vehicle communicator/communication interface 152, a sensor condition determiner/unit 153, a valve driver 154, a mode converter 155, and a time measurer 156 (e.g., a timer, counter and/or clock).

The sensing part 151 may include the pressure sensor 130 and the temperature sensor 140.

The sensing part 151 may detect/receive a pressure (supply pressure) of hydrogen from the pressure sensor 130. The pressure sensor 130 may measure the pressure of hydrogen that has supplied to the regulator 120 from the hydrogen tank 110 and transmit the measured pressure to the controller 150. Also, or alternatively, the pressure sensor 130 may transmit a signal/information based on the measured pressure, such as a signal (e.g., warning/alert/confirmation) indicating whether the measured pressure satisfies the specific supply pressure and/or specific supply pressure range.

The sensing part 151 may sense a device temperature via the temperature sensor 140. The temperature sensor 140 may be configured to measure a temperature of the hydrogen in the interior of the hydrogen storage device 100. For example, the temperature sensor 140 may be configured to measure a temperature of the hydrogen between the at least one hydrogen tank 110 and the regulator 120. Also, or alternatively, the temperature sensor 140 may be configured to measure a temperature of the hydrogen in the at least one hydrogen tank 110. In general, the temperature sensor 140 may be configured to measure a temperature of hydrogen being supplied to the regulator 120.

The vehicle communicator 152 may support wired communication and/or wireless communication (e.g., with one or more other controllers in the fuel cell vehicle, the temperature sensor 140, the pressure sensor 130, and/or the regulator 120, etc.). The vehicle communicator 152 may include a wired communication circuit and a wireless communication circuit. The wired communication circuit may communicate with the external electronic device by using a local area network (LAN), a wide area network (WAN), Ethernet, and/or an integrated services digital network (ISDN). The wireless communication circuit may communicate with the external electronic device by using mobile communication, short-range wireless communication (Bluetooth, near field communication (NFC), and/or infrared communication (Infrared Data Association (IrDA))), and/or wireless Internet communication (Wi-Fi).

The sensor condition determiner 153 may determine the pressure condition and/or the temperature condition of hydrogen based on information received from the pressure sensor 130 and/or the temperature sensor 140. The sensor condition determiner 153 may selectively control opening and/or closing operations of the regulator valve 121 and the thermal management system (TMS) valve 123. The sensor condition determiner 153 may selectively control whether the valves 121 and/or 123 are to be opened and/or closed by/via a valve driver 154. For example, the sensor condition determiner may send a signal to cause the valve driver 154 to open and/or closed the valves 121 and/or 123. The sensor condition determiner 153 may selectively control, based on determining that a temperature of the temperature sensor 140 and/or a pressure of the pressure sensor 130 does not satisfy a reference value (e.g., (e.g., is outside of an allowed range of the reference value, is greater than the reference value, is less than a reference value, etc., where a reference value may be, for example, the specific supply pressure and/or a reference temperature).

The sensor condition determiner 153 may control a regulator valve 121 to open to compensate for the pressure of hydrogen supplied from the hydrogen tank 110 to the regulator 120. For example, when/if the pressure of hydrogen supplied to the regulator 120 decreases (e.g., due to degradation of an operability of the regulator 120 and/or be outside of a specific supply pressure range, such as measured by the pressure sensor 130) the sensor condition determiner 153 may control a regulator valve 121 to open.

The sensor condition determiner 153 may cause discharging of hydrogen (e.g., to an outside of the hydrogen storage device 100 to protect the regulator 120 from an excessive pressure) via/by the TMS valve 123. For example, when/if the pressure of hydrogen supplied to and/or from the regulator 120 rises excessively (e.g., to meet and/or exceed an allowed regulator pressure/tank pressure and/or allowed supply pressure, and/or in a high-temperature and/or high-pressure environment of the regulator 120)., the TMS valve 123 may control the operation temperature of the fuel cell stack 160 (e.g., by opening or closing to control pressure of hydrogen to the regulator 120 and/or fuel cell stack).

The regulator valve 121 and the TMS valve 123 may be selectively operated by the valve driver 154 (e.g., based on signals/information received from the sensor condition determiner 153).

The controller 150 may include a mode converter 155 that converts the hydrogen storage device 100 from a sleep mode to a wakeup mode and/or from the wakeup mode to the sleep mode. For example, the mode converter 155 may convert the hydrogen storage device 100 from the sleep mode to the wakeup mode due to an ignition made in a key-on state of the fuel cell vehicle.

The mode converter 155 may convert the sleep mode to the wakeup mode when minimum electric power is supplied to an electronic control unit (ECU; e.g., comprising and/or in communication with the controller 150) in the sleep mode, in which an ignition power source is not operated.

As an example, in the logic of the mode converter 155, the controller 150 may operate the hydrogen storage device 100 in the sleep mode when/if it is determined that the hydrogen storage device 100 may enter the sleep mode based on communication between controllers and/or components in the fuel cell vehicle in a first state in which the ignition power source is turned off, and/or the controller 150 may maintain the wakeup mode when/if it is determined that it is not possible to enter the sleep mode yet.

In the logic of the mode converter 155, the controller 150 may operate the hydrogen storage device 100 in the wakeup mode when/if it is determined that the hydrogen storage device 100 may enter the wakeup mode based on communication between the controllers in the fuel cell vehicle in a second state in which the ignition power source is supplied, and/or the controller 150 may maintain the sleep mode when/if it is determined that it is not possible to enter the wakeup mode yet.

The ignition power source may directly supply electric power to the controller 150. The controller 150 may be converted/set to the wakeup mode or the sleep mode based on detection/receipt of an ignition signal that is a wakeup signal, or a lack thereof, respectively.

A time measurer 156 (e.g., timer, counter, clock, etc.) may be provided for measuring times of the sleep mode and the wakeup mode and transmitting the measured times and/or signals based thereon to the controller 150.

As an example, the mode may be converted to the sleep mode when/if the ignition power source is turned off within a first time measured by the time measurer 156, and the sleep mode may be converted to the wakeup mode when/if the ignition power source is turned on within the first time period.

Conversion to the wakeup mode may mean outputting a wakeup signal, and the controller 150 may, based on receiving/detecting the wakeup signal, wake up (convert from the sleep mode to the wakeup mode) so as to sense the temperature and/or the hydrogen pressure measured by the sensing part 151.

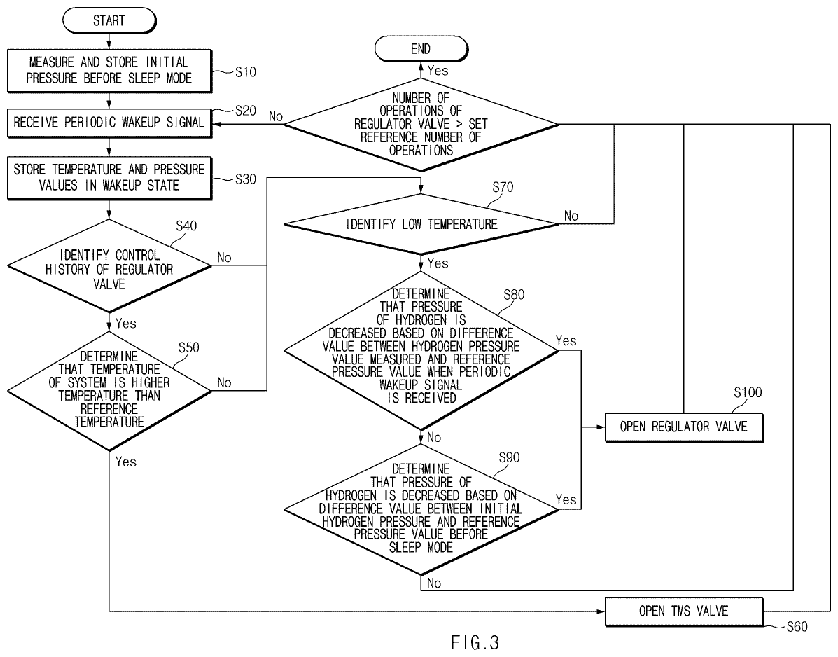

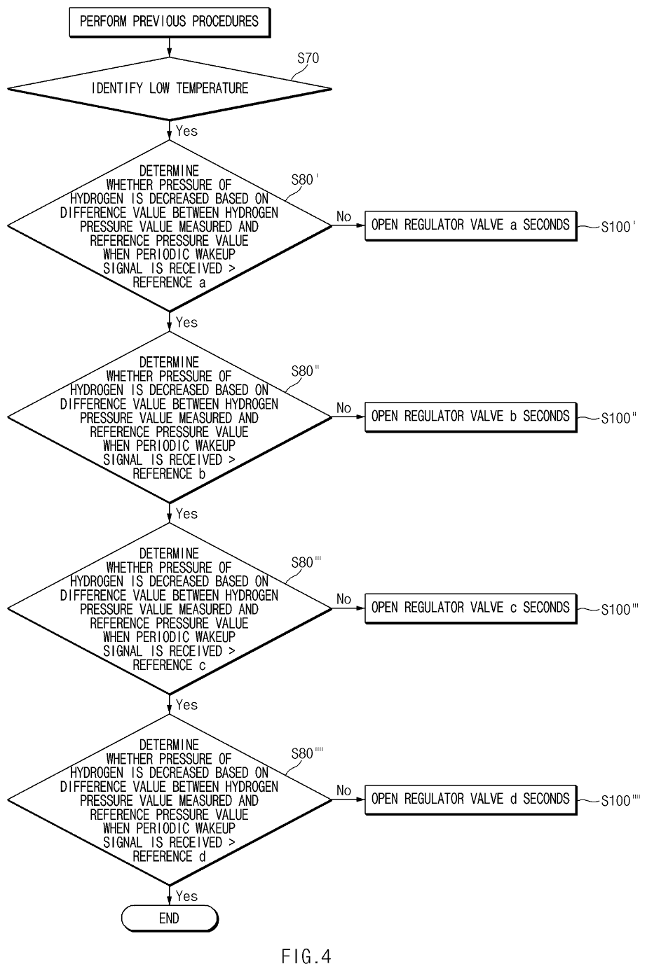

Methods for controlling a regulator for a fuel cell vehicle according to an example of the present disclosure will be described with reference to FIGS. 3 and 4.

FIG. 3 is a flowchart illustrating a method for controlling a regulator for a fuel cell vehicle according to an example of the present disclosure. For convenience, FIG. 3 is described by way of an example in which the steps are performed by a processor circuit. One, some, or all steps of the example method of FIG. 3, or portions thereof, may be performed by one or more other circuits. One or some, steps of the example method of FIG. 3 may be omitted, performed in other orders, and/or otherwise modified, and/or one or more additional steps may be added.

Referring to FIG. 3, the mode converter 155 may perform conversion to the sleep mode in a state in which the ignition power source of the fuel cell vehicle is turned off.

Before the sleep mode is entered (e.g., due to an off signal of the ignition power source of the fuel cell vehicle), an initial pressure of hydrogen supplied to the regulator 120 may be measured, the data indicating the initial pressure may be acquired by and/or stored in the memory (S10).

The controller 150 may perform conversion to the wakeup mode by supplying, via the vehicle communicator 152 in the sleep mode, a minimum electric power to the vehicle ECU. When/if a wakeup signal is received (e.g., periodically/repeatedly received), the mode may be switched from the sleep mode to the wakeup mode (S20).

The controller 150 may receive, from/via the sensing part 151, data indicating the temperature of the interior of the hydrogen storage device 100 and/or the pressure of hydrogen supplied to the regulator 120. For example, the controller 150 may, based on receiving a wakeup signal, receive and/or store first data indicating the temperature (e.g., measured by the temperature sensor 140) and/or second data indicating the pressure (e.g., measured by the pressure sensor 130). For example, the controller 150 may, based on the receiving the wakeup signal, control the temperature sensor 140 to acquire and/or transmit the first data and/or the pressure sensor 130 to acquire and/or transmit the second data. The controller may, acquire the data (e.g., the first data and/or the second data), and/or store the data in the memory (S30).

An operation history of the regulator valve 121 may be identified (S40). The operation history of the operated regulator valve 121 may be identified to compensate for lowering of the pressure of hydrogen, which may occur due to degradation of the operability of the regulator 120 in a low-temperature environment of the fuel cell vehicle, for example.

The controller 150 may acquire the operation history of the regulator valve 121 and store the acquired operation history in the memory (S40).

The controller 150 may identify that the operation history of the regulator valve 121 is a pressure compensation history of the regulator valve 121 due to a failure of a pressure maintenance performance of the regulator 120 (e.g., in the low-temperature environment of the fuel cell vehicle). For example, the controller 150 may determine that the operation history indicates a failure of the regulator 120 maintaining supply pressure to the fuel cell stack.

The sensor condition determiner 153 may determine whether the temperature of the interior or the hydrogen storage device 100 satisfies (e.g., is higher than) a reference temperature (S50). When/if the sensor condition determiner 153 determines that the temperature of the interior of the hydrogen storage device 100 higher than the reference temperature (e.g., the pressure of hydrogen correspondingly rises such that the supply pressure an excessive pressure) (S50—Yes), the controller 150 may transmit a control signal to the valve driver 154 and control the TMS valve 123 to be operated in an opened state (e.g., to open) (S60). For example, if the temperature of the interior of the hydrogen storage device 100 is measured as higher than the reference temperature, the pressure of hydrogen may excessively rise even while the operability degradation problem of the regulator 120 is not solved. Opening the TMS valve 123 may reduce the pressure and/or the temperature. The supply pressure may be maintained by discharging hydrogen (e.g., to the outside of the hydrogen storage device 100) to protect the hydrogen storage device 100 from an excessive pressure.

When/if the sensor condition determiner 153 determines that the temperature of the interior of the hydrogen storage device 100 higher than the reference temperature (S50—No), the sensor condition determiner 153 may determine whether the temperature of the interior or the hydrogen storage device 100 satisfies (e.g., is lower than) the reference temperature (S70). When/if it is determined that the temperature of the interior of the hydrogen storage device 100 (e.g., measured by the temperature sensor 140) is a lower temperature than the reference temperature (S70—Yes). When/if the sleep mode is (e.g., periodically/repeatedly) converted to the wakeup mode and it is determined that there is a low-temperature environment of the fuel cell vehicle (S70—Yes), a first difference value between the pressure value of hydrogen, which is measured by the pressure sensor 130, and a reference pressure value may be determined(S80: S80′-S80″″). If the first difference value does

If the first difference value does not indicate a decrease in the measured hydrogen value and the reference pressure (S80—No), a second difference value between an initial pressure value of hydrogen before the sleep mode was entered and the reference pressure value may be determined (S90).

When/if is the first difference value or the second difference value indicates that measured hydrogen pressure is lower than the reference pressure value (S80—Yes; or S90—Yes) (e.g., due to degradation of the operability of the regulator 120), the pressure may be compensated for by opening the regulator valve 121 (S100: S100′-S100″″). This may prevent a failure of the regulator 120 maintaining the supply pressure (e.g., due to degradation of the operability of the regulator 120, such as at a low temperature).

FIG. 4 is a flowchart illustrating a method for controlling a regulator for a fuel cell vehicle according to another example of the present disclosure. For convenience, FIG. 4 is described by way of an example in which the steps are performed by a processor circuit. One, some, or all steps of the example method of FIG. 4, or portions thereof, may be performed by one or more other circuits. One or some, steps of the example method of FIG. 4 may be omitted, performed in other orders, and/or otherwise modified, and/or one or more additional steps may be added.

In FIG. 4, the previous procedures S10 to S70 of FIG. 3 may be still performed, and the procedure S80 and S90 of FIG. 3 may be as follows.

When/if it is determined that the temperature of the interior of the hydrogen storage device 100, which is measured by the sensor condition determiner 153, is a lower temperature than the reference temperature (S70—Yes), that is, when the sleep mode is (e.g., periodically/repeatedly converted to the wakeup mode in the physical low-temperature environment of the fuel cell vehicle, it may be determined whether there is a decrease in the pressure of hydrogen based on a difference value between the pressure value of hydrogen (e.g., measured by the pressure sensor 130), and the reference pressure value (S80′ to S80″″).

When/if it is determined that the pressure value measured by the sensing part 151 is lower than the reference pressure value (e.g., S80′ to S80″″—Yes) (e.g., due to degradation of the operability of the regulator 120), the pressure may be compensated for by opening the regulator valve 121 (S100).

By this process, the measured result value of the hydrogen pressure value may be changed when/if the sleep mode is (e.g., periodically/repeatedly) converted to the wakeup mode, and a large measured hydrogen pressure value may be reduced to a relatively small value.

The measured result value of the initial hydrogen pressure value may be a relatively large value, while a smaller value may be acquired as time elapses.

According to an example of the present disclosure, the measured result value of the hydrogen pressure value may be set for respective stages from a small value to a large value. This means that the decrease in the hydrogen pressure increases as the measured result value of the hydrogen pressure value increases. The operation time of the regulator valve 121 may be determined based on the measured result value of the hydrogen pressure. Accordingly, as the measured result value of the hydrogen pressure value increases, the opening operation time of the regulator valve 121 (e.g., a, b, c, d) may be maintained for a longer time.

Accordingly, as the decrease in the hydrogen pressure value increases, the opening operation time of the regulator valve 121 may be increased to increase the pressure compensation amount (S100′-S100″″).

Because a functional failure of the regulator 120 is generated as the number of operations of the regulator valve 121 in the sleep mode is increased, the operation of the regulator valve 121 may be controlled to be performed only a preset number of times to prevent this.

Because the present disclosure improves an operation performance related to adjustment of the pressure of the regulator 120 by securing stabilization of the pressure relief valve that causes a leakage problem due to a failure of the pressure maintenance performance of the regulator 120, leakage and operation noise of the pressure relief valve may be solved/improved.

At the same time, to solve the leakage and operation noise problem due to exposure to an excessive pressure of the pressure relief valve, the hydrogen storage device 100 may be protected by discharging hydrogen of an excessive pressure generated in the regulator 120 to the outside through control of the TMS valve 123.

The present disclosure has been made to solve the above-mentioned problems occurring in the prior art while advantages achieved by the prior art are maintained intact.

The present disclosure provides a hydrogen storage device for a fuel cell vehicle that may secure stabilization of a pressure relief valve that causes a leak problem due to a failure of a pressure maintenance performance of a regulator and may protect the hydrogen storage device from an excessive pressure by discharging hydrogen of the excessive pressure generated in the regulator to an outside as well, and a method for controlling the same.

Objects of the present disclosure are not limited to the explicitly mentioned objects, and other objects and advantages of the present disclosure than those explicitly mentioned herein will be understood by those skilled in the art. It will be easily understood that the objects and advantages of the present disclosure may be realized by the appended claims.

According to the present disclosure, a hydrogen storage device for a fuel cell vehicle may include a controller including a sensing part that measures a change value of a pressure of hydrogen in a regulator by using a pressure sensor in a hydrogen storage device in a physical low-temperature environment of a fuel cell vehicle, and that controls the regulator to compensate for a pressure of hydrogen when the pressure of hydrogen in the regulator is lowered based on the change value of the pressure of hydrogen in the regulator measured by the sensing part, and a regulator valve that compensates for the pressure of hydrogen in the regulator.

According to an example of the present disclosure, the controller may include a sensor condition determiner that determines a pressure condition and a temperature condition of hydrogen sensed by the sensing part, and a valve driver that selectively controls whether the regulator valve is to be opened or closed depending on the pressure condition and the temperature condition of hydrogen determined by the sensor condition determiner.

According to an example of the present disclosure, an opening condition of the regulator valve may include a state, in which the pressure of hydrogen is decreased based on a difference value between a hydrogen pressure value measured by the pressure sensor and a reference pressure value when a mode converter of the fuel cell vehicle is periodically converted from a sleep mode to a wakeup mode.

According to an example of the present disclosure, an opening condition of the regulator valve may include a state, in which the pressure of hydrogen is decreased based on a difference value between an initial hydrogen pressure value before a mode converter of the fuel cell vehicle enters a sleep mode, and a reference pressure value.

According to an example of the present disclosure, the hydrogen storage device may include a TMS valve configured to discharge the pressure of hydrogen supplied to the regulator to an outside to protect the regulator from an over pressure in a high-temperature and high-pressure environment of the regulator.

According to the present disclosure, a method for controlling a hydrogen storage device for a fuel cell vehicle may include measuring an initial pressure of hydrogen supplied to a regulator and storing the measured initial pressure before a fuel cell vehicle enters a sleep mode according to an off signal of an ignition power source, measuring a temperature of an interior of a hydrogen storage device and a pressure of hydrogen supplied to the regulator by a temperature sensor and a pressure sensor of a hydrogen storage device and storing the measured temperature and pressure when a wakeup signal is periodically received, identifying a control history of a regulator valve, determining that the temperature of the interior of the hydrogen storage device measured by the temperature sensor is a low temperature being lower than a reference temperature, determining that the pressure of hydrogen in the regulator is a lower pressure than a reference pressure, and compensating for the pressure of hydrogen in the regulator by opening the regulator valve when it is determined that the pressure of hydrogen in the regulator is the lower pressure than the reference pressure.

According to an example of the present disclosure, an opening condition of the regulator valve may include a state, in which the pressure of hydrogen is decreased based on a difference value between a hydrogen pressure value measured by the pressure sensor and a reference pressure value when a mode converter of the fuel cell vehicle is periodically converted from a sleep mode to a wakeup mode.

According to an example of the present disclosure, an opening condition of the regulator valve may include a state, in which the pressure of hydrogen is decreased based on a difference value between an initial hydrogen pressure value before a mode converter of the fuel cell vehicle enters a sleep mode, and a reference pressure value.

According to an example of the present disclosure, an opening condition of the regulator valve may include both of a state, in which the pressure of hydrogen is decreased based on a difference value between a hydrogen pressure value measured by the pressure sensor and a reference pressure value when a mode converter of the fuel cell vehicle is periodically converted from a sleep mode to a wakeup mode, and a state, in which the pressure of hydrogen is decreased based on a difference value between an initial hydrogen pressure value before a mode converter of the fuel cell vehicle enters a sleep mode, and a reference pressure value.

According to an example of the present disclosure, an opening condition of the regulator valve may include a state, in which a measured result value of a pressure value of hydrogen is decreased from a large value to smaller values for respective stages based on a difference value between a hydrogen pressure value measured by the pressure sensor and a reference pressure value when a mode converter of the fuel cell vehicle is periodically converted from a sleep mode to a wakeup mode.

According to an example of the present disclosure, when a decrease in the measured result value of the pressure value of hydrogen is decreased for the respective stages, an opening operation time of the regulator valve may be set to be increased.

According to the present disclosure, a method for controlling a hydrogen storage device for a fuel cell vehicle may include measuring an initial pressure of hydrogen supplied to a regulator and storing the measured initial pressure before a fuel cell vehicle enters a sleep mode according to an off signal of an ignition power source, measuring a temperature of an interior of a hydrogen storage device and a pressure of hydrogen supplied to the regulator by a temperature sensor and a pressure sensor of a sensing part of a hydrogen storage device and storing the measured temperature and pressure when a wakeup signal is periodically received, identifying a control history of a regulator valve, determining that the temperature of the interior of the hydrogen storage device measured by the temperature sensor is a higher temperature than a reference temperature, and discharging hydrogen in the hydrogen storage device by opening a value unit to an outside to maintain a middle pressure state when the pressure of hydrogen supplied in a high-temperature environment of the hydrogen storage device rises.

According to the hydrogen storage device for a fuel cell vehicle and the method for controlling the same according to the present disclosure having the above-described configuration, because the operation performance related to the adjustment of the pressure of the regulator may be improved by securing stabilization of the pressure relief valve that causes a leak problem due to a failure of the pressure maintenance performance of the regulator, a complaint of the user due to leakage and operation noise of the pressure relief valve (RPV) may be solved.

At the same time, the hydrogen storage device may be protected from an excessive pressure by discharging hydrogen of an excessive pressure generated in the regulator to the outside.

The above-mentioned description of the present disclosure is intended to be illustrative, and it should be understood by those skilled in the art that the present disclosure may be embodied in other specific forms without departing from the spirit or essential characteristics thereof. Therefore, the above-described examples are examples in all aspects, and should be construed not to be restrictive. The scope of the present disclosure is defined by claims to be described below, and it should be interpreted that the scopes or claims of the present disclosure and all modifications or changed forms derived from the equivalent concept are included in the scopes of the present disclosure.

What is claimed is:

1. A hydrogen storage device for a fuel cell vehicle, comprising:
a controller comprising:
one or more processors; and
a memory storing instructions that, when executed, configure the controller to:
detect, via a pressure sensor, a pressure of hydrogen supplied to a regulator;
detect, via a temperature sensor, a temperature of hydrogen in the hydrogen storage device; and
determine, based on the pressure and the temperature, a change in the pressure of hydrogen supplied to the regulator, and
control, based on the change in the pressure indicating a lowered pressure, the regulator to compensate for the change in the pressure; and
the regulator configured to compensate, by opening or closing a regulator valve of the regulator based on the control by the controller, for the change in the pressure.

2. The hydrogen storage device of claim 1, wherein the controller is configured to:
determine, based on the detected pressure and the detected temperature, a pressure condition and a temperature condition of hydrogen; and
selectively control, based on the pressure condition and the temperature condition, whether the regulator valve is to be opened or closed.

3. The hydrogen storage device of claim 1, wherein the controller is configured to control, based on a mode of the fuel cell vehicle being repeatedly converted from a sleep mode to a wakeup mode and based on a difference between the pressure and a reference pressure indicating a decreased pressure, the regulator valve to open.

4. The hydrogen storage device of claim 1, wherein the controller is configured to control, based on a difference between an initial pressure measured before a mode of the fuel cell vehicle enters a sleep mode and a reference pressure value indicating a decreased pressure, the regulator valve to open.

5. The hydrogen storage device of claim 1, wherein the controller is configured to control the regulator valve to open based on:
a first difference, between the pressure measured after a mode of the fuel cell vehicle is repeatedly converted from a sleep mode to a wakeup mode and a reference pressure, indicating a decreased pressure; or
a second difference, between an initial hydrogen pressure measured before a mode converter of the fuel cell vehicle enters a sleep mode and a reference pressure value, indicating a decreased pressure.

6. The hydrogen storage device of claim 1, wherein the controller is configured to control, based on a difference between the pressure and a reference pressure indicating a decreased pressure and in response to a mode of the fuel cell vehicle being repeatedly converted from a sleep mode to a wakeup mode, the regulator valve to open for an opening operation time and close repeatedly.

7. The hydrogen storage device of claim 6, wherein the opening operation time increases for successive openings of the regulator valve.

8. The hydrogen storage device of claim 1, comprising:
a thermal management system valve configured to discharge a pressure of hydrogen supplied to the regulator based on a high-temperature or high-pressure of the hydrogen supplied to the regulator.

9. The hydrogen storage device of claim 8, wherein the controller is configured to selectively control, based on the detected temperature or a pressure of the hydrogen supplied to the regulator, the thermal management system valve to open or close.

10. A method for controlling a hydrogen storage device for a fuel cell vehicle, the method comprising:
detecting, via a pressure sensor and based on an off-signal of an ignition power source of the fuel cell vehicle, an initial pressure of hydrogen supplied to a regulator ;
based on detecting a repeated wakeup signal:
detecting, via a temperature sensor, a temperature of an interior of a hydrogen storage device; and
detecting, via the pressure sensor, a pressure of hydrogen supplied to the regulator;
based on the temperature being lower than a reference temperature, determining that at least one of the pressure of hydrogen or the initial pressure is lower than a reference pressure; and
causing, based on the pressure or the initial pressure being lower than the reference pressure, opening of a regulator valve of the regulator.

11. The method of claim 10, wherein the causing of the opening of the regulator valve is based on a difference between the pressure of hydrogen and the reference pressure in response to a mode of the fuel cell vehicle being periodically converted from a sleep mode to a wakeup mode.

12. The method of claim 10, wherein the causing of the opening of the regulator valve is based on a difference between the initial pressure, before a mode of the fuel cell vehicle enters a sleep mode, and the reference pressure.

13. The method of claim 10, wherein the causing of the opening of the regulator valve comprises is based on:
a difference, between a pressure of hydrogen measured by the pressure sensor and a reference pressure value in response to a mode of the fuel cell vehicle being periodically converted from a sleep mode to a wakeup mode, indicating a decreased pressure; or
a difference, between an initial pressure before a mode of the fuel cell vehicle enters a sleep mode and a reference pressure, indicating a decreased pressure.

14. The method of claim 10, wherein the causing of the opening of the regulator valve comprises causing, based on a mode of the fuel cell vehicle being converted from a sleep mode to a wakeup mode and based on a difference between the pressure of hydrogen and a reference pressure, repeated openings of the regulator valve.

15. The method of claim 14, wherein, based on a decreased value in the pressure of hydrogen being decreased for respective repeated openings, an opening operation time of each opening of the repeated openings increases.

16. The method of claim 10, further comprising:
based on a second temperature measured by the temperature sensor being higher than a reference temperature, causing opening of a valve to discharge hydrogen from the hydrogen storage device to an outside to maintain a pressure in the regulator.

17. A method for controlling a hydrogen storage device for a fuel cell vehicle, the method comprising:
detecting, via a pressure sensor and based on an off-signal of an ignition power source of the fuel cell vehicle, an initial pressure of hydrogen supplied to a regulator;
based on detecting a repeated wakeup signal:
detecting, via a temperature sensor, a temperature of an interior of a hydrogen storage device; and
detecting, via the pressure sensor, a pressure of hydrogen supplied to the regulator; and
based on the temperature being higher than a reference temperature, causing opening of a valve to discharge hydrogen from the hydrogen storage device to an outside to maintain a pressure state in the regulator.

18. The method of claim 17, wherein the valve is a thermal management system (TMS) valve.

19. The method of claim 17, further comprising:
based on a second temperature measured by the temperature sensor being lower than a reference temperature, determining that at least one of the pressure of hydrogen or the initial pressure is lower than a reference pressure; and
causing, based on the pressure or the initial pressure being lower than the reference pressure, opening of a regulator valve of the regulator.
